(19) United States
(12) Patent Application Publication
(10) Pub. No.: US 2006/0176901 A1
(43) Pub. Date: Aug. 10, 2006

(54) Method and apparatus for data processing, and computer product

(75) Inventors: Yoshiyuki Terai, Kawasaki (JP); Isamu Kawamura, Kawasaki (JP)

Correspondence Address: Patrick G. Burns, Esq.;GREER, BURNS & CRAIN, LTD., Suite 2500, 300 South Wacker Dr, Chicago, IL, 60606, US

(73) Assignee: FUJITSU LIMITED

(21) Appl. No.: 11/132,474

(22) Filed: May 19, 2005

(30) Foreign Application Priority Data
Feb. 7, 2005 (JP) 2005-030634

(51) Int. Cl. H04J 3/22; H04L 12/28; H04J 3/18; H04L 12/56; H04J 3/16

(52) U.S. Cl. 370/465; 370/392; 370/477

(57) ABSTRACT

A data processing apparatus includes a receiving unit that receives a plurality of pieces of data, each of which having a different destination specified; a classifying unit that classifies the plurality of pieces of data into a predetermined number of groups; a sorting unit that extracts data from the groups in a parallel manner, and that sorts the data extracted according to a destination; and an output unit that outputs a set of the data sorted to a corresponding destination.

### CROSS-REFERENCE TO RELATED APPLICATIONS

This application is based upon and claims the benefit of priority from the prior Japanese Patent Application No. 2005-030634, filed on Feb. 7, 2005, the entire contents of which are incorporated herein by reference.

### BACKGROUND OF THE INVENTION

1) Field of the Invention

The present invention relates to a technology for data processing for implementing an enterprise service bus (ESB).

2) Description of the Related Art

Conventionally, in system cooperation technology, application linkage with a work flow and data linkage are implemented without differentiation. The work flow includes a task work flow that is a system control over a flow of task that is recognizable by human. The task work flow has mixed functions with an execution mechanism for the data linkage, and a definition view. The task work flow is intended for use in an environment in which data volume is relatively small and the number of destinations for sorting is relatively small. In other words, the execution mechanism and the definition view in the task work flow are not suitable for a large data volume and a large number of destinations for sorting.

Conventionally, for a task processing system in banks and companies, enterprise application integration (EAI) has been used. The EAI is a system for binding internal and external information systems together. With the EAI, task systems can be efficiently linked as if to insert into a socket. In the EAI, task data from one of the task systems can be passed to more than one task system by, for example, performing a sorting process for sorting the task data according to destinations or a format conversion process.

FIG. 13 is a schematic of a conventional EAI. In an EAI 1300 shown in FIG. 13, a data processing apparatus 1301 serving as a hub receives task data D1 to D5, such as slips and telegraphic messages, from task systems 1311 to 1315, performs various processes such as a format conversion process on the task data D1 to D5, and then transmits the task data D1 to D5 processed to the task systems 1311 to 1315. With the EAI 1300, concurrent processing of the task data D1 to D5 can be achieved. A size of figures representing each of the task data D1 to D5 shown in FIG. 13 corresponds a size of the data volume or the number of pieces of data.

Also, as an infrastructure of application integration, a technological field called ESB advanced from EAI has been developed. The ESB is based on a concept of integrating systems in conformity with open standard specifications, such as web services and Java Connector Architecture (JCA), and expands availability of the EAI, by, for example, increasing a size of intra-system linkage. In some cases, with real-time linkage of single slips or small-volume data and linkage of batch data and attachments received from a main system being simultaneously performed, a million of pieces of data or large-volume data in gigabytes for approximately thousand destinations for sorting are handled, and therefore a high linking mechanism suitable for such cases has to be devised. Furthermore, it is preferable that such mechanism is automatically optimized without requiring complex settings.

Conventionally, a technology of interconnecting different types of applications via a network without alterations to existing systems to achieve interavailability between data and functions has been disclosed (refer to, for example, Japanese Patent Application Laid-Open Publication No. 2000-187626). In another technology, a fax machine temporarily stores contents to be faxed in memory together with information on destinations and scheduled transmission times, and then transmits contents that are scheduled to be transmitted at the same time and to the same destination when a predetermined time comes (refer to, for example, Japanese Patent Application Laid-Open Publication No. H2-159148). Furthermore, in still another technology, contents to be faxed are temporarily stored in memory and, when a predetermined time comes, contents to be transmitted to the same destination are collectively transmitted to the destination, thereby saving communication cost (refer to, for example, Japanese Patent Application Laid-Open Publication No. H1-000879).

However, in the EAI 1300 shown in FIG. 13, the task data D1 to D5 are different from each other in data volume and the number of pieces of data. In addition, the task data D1 to D5 vary depending on a period (end of a month, a year, or a fiscal year). For example, the task data D1 shown in FIG. 13 from the task system 1311 is larger than any other one of the task data D2 to D5.

When the task system 1311 transmits a large amount of task data D1 to the data processing apparatus 1301, the data processing apparatus 1301 requires a large amount of time to perform a data process, such as the sorting process and the format conversion process on the task data D1. If there are the task data D2 to D5 to be processed after the task data D1, the task data D2 to D5 cannot be processed due to a delay in data processing caused by the large amount of data, the task data D1.

Furthermore, performance is degraded when the data volume and the number of destinations are large. The task data sorted according to destinations is separately stored and processed as tasks are distributed. Therefore even when operations are defined to be performed concurrently, pieces of task data are sequentially processed to keep consistency in the work flow. In addition, since in the definition view, branches are described on a screen, it is difficult to establish definitions when the number of braches increases.

### SUMMARY OF THE INVENTION

It is an object of the present invention to at least solve the problems in the conventional technology.

A data processing apparatus according to one aspect of the present invention includes a receiving unit that receives a plurality of pieces of data, each of which having a different destination specified; a classifying unit that classifies the plurality of pieces of data into a predetermined number of groups; a sorting unit that extracts data from the groups in a parallel manner, and that sorts the data extracted according to a destination; and an output unit that outputs a set of the data sorted to a corresponding destination.

A computer-readable recording medium according to another aspect of the present invention stores a data processing program for realizing the data processing method according to the above aspect on a computer.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of an EAI according to an embodiment of the present invention;

FIG. 2 is a block diagram of a hardware configuration of a data processing apparatus 101 and task systems according to the embodiment;

FIG. 3 is a block diagram of a functional configuration of the data processing apparatus 101 according to the embodiment;

FIG. 4 is a schematic for illustrating an input process according to the embodiment;

FIG. 5 is a schematic for illustrating a sorting process according to the embodiment;

FIG. 6 is a schematic for illustrating combined task data;

FIG. 7 is a schematic for illustrating a format conversion process according to the embodiment;

FIG. 8 is a flowchart of data processing by the data processing apparatus;

FIG. 9 is a flowchart of the sorting process;

FIG. 10 is a flowchart of a storing process according to the embodiment;

FIG. 11 is a flowchart of the format conversion process;

FIG. 12 is a block diagram of a specific configuration of the data processing apparatus; and

FIG. 13 is a schematic of a conventional EAI.

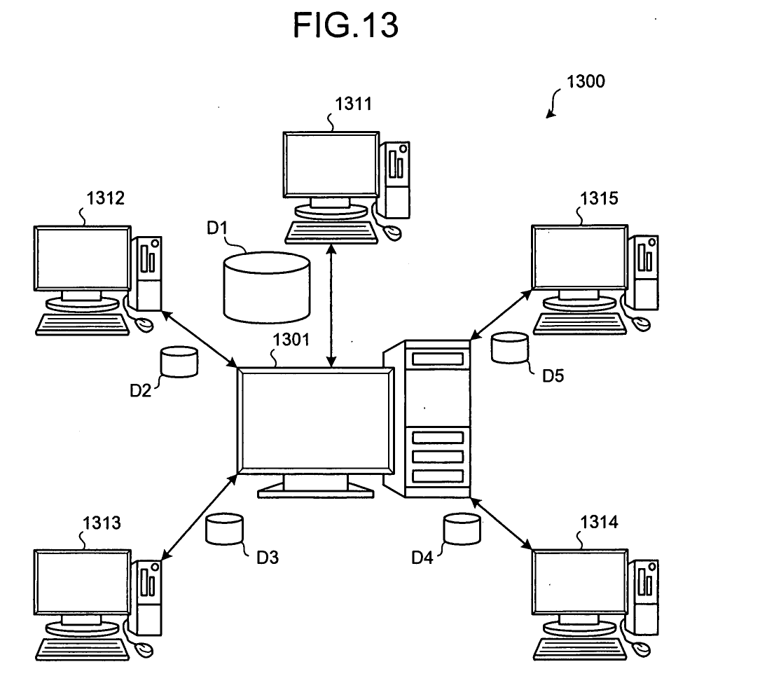

### DETAILED DESCRIPTION

With reference to the attached drawings, an exemplary embodiment of the present invention is described in detail below.

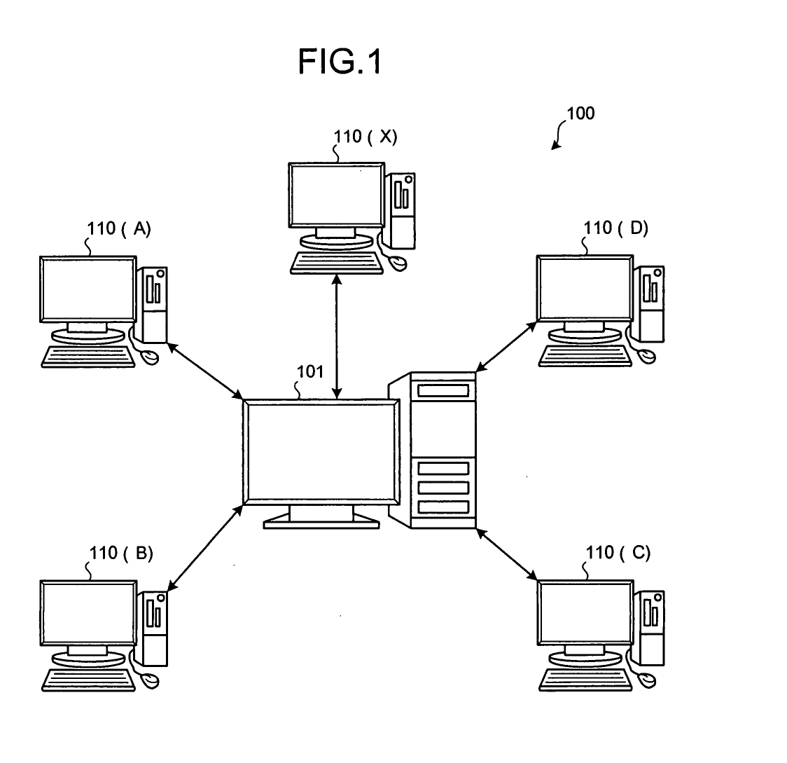

FIG. 1 is a schematic of a system configuration of EAI according to an embodiment of the present invention. In EAI 100 shown in FIG. 1, a data processing apparatus 101 serving as a hub and task systems 110 (A to D and X) that transmit and receive task data to the data processing apparatus 101 are linked to one another so as to mutually communicate with one another. The EAI 100 is one type of a system for binding internal and external information systems. In the present embodiment, task data regarding slips are described as an example.

Task data transmitted from the task system 110 is captured by the data processing apparatus 101, and undergoes a sorting process for sorting the task data according to a destination and a conversion process for converting the task data into a format identical to a format used in the task system 110 to be the destination in the data processing apparatus 101. Then, the task data is transmitted to the task system 110 to be the destination. Examples of the task systems 110 include call centers, production management systems, sales management systems, agent systems, help desks, and the Internet systems.

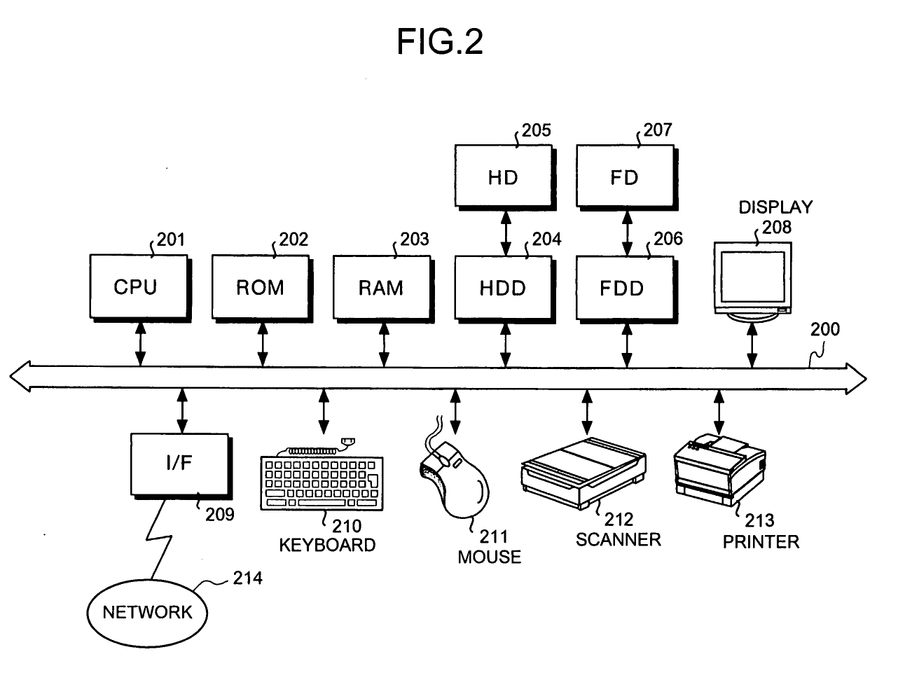

FIG. 2 is a block diagram of a hardware configuration of the data processing apparatus and the task system according to the embodiment. As shown in FIG. 2, the data processing apparatus 101 and the task system include a central processing unit (CPU) 201, a read-only memory (ROM) 202, a random-access memory (RAM) 203, a hard disk drive (HDD) 204, a hard disk (HD) 205, a flexible disk drive (FDD) 206, a flexible disk (FD) 207 as an example of a removable recording medium, a display 208, an interface (I/F) 209, a keyboard 210, a mouse 211, a scanner 212, and a printer 213. The components are connected to each other by a bus 200.

The CPU 201 controls a whole of the data processing apparatus 101 and the task system. The ROM 202 stores a computer program such as a boot program. The RAM 203 is used as a work area for the CPU 201. The HDD 204 controls read/write of data from/to the HD 205 in accordance with the control of the CPU 201. The HD 205 stores data that is written in accordance with the control of the HDD 204.

The FDD 206 controls read/write of data from/to the FD 207 in accordance with the control of the CPU 201. The FD 207 stores data that is written by a control of the FDD 206 and lets the data processing apparatus 101 read the data stored in the FD 207.

Other than the FD 207, examples of the removable recording medium include a compact disk read-only memory (CD-ROM), such as compact disc-recordable (CD-R) or compact disc-rewritable (CD-RW), a magnet-optical (MO) disk, a Digital Versatile Disk (DVD), or a memory card. The display 208 displays data, such as documents, images, and function information, including a cursor, icons, or toolboxes. As the display 208, for example, a cathode-ray tube (CRT), a thin-film transistor (TFT) liquid crystal display, or a plasma display can be adopted.

The I/F 209 is connected to a network 214, such as the Internet, via a communication line and is connected to other devices via the network 214. The I/F 209 controls the network 214 and an internal interface to control input/output of data to/from external devices. A modem or a local area network (LAN) adapter can be used as the I/F 209.

The keyboard 210 includes keys for inputting characters, numbers, and various instructions, and is used to input data. A touch panel input pad or a numerical key pad may also be used as the keyboard 210. The mouse 211 is used to shift the curser, select a range, shift windows, and change sizes of the windows on a display. A track ball or a joy stick may be used as a pointing device if functions similar to those of the mouse 211 are provided.

The scanner 212 optically captures an image and inputs image data to the data processing apparatus 101 and the task system. The scanner 212 may be provided with an optical character read (OCR) function. The printer 213 prints image data and document data. For example, a laser printer or an inkjet printer may be used as the printer 213.

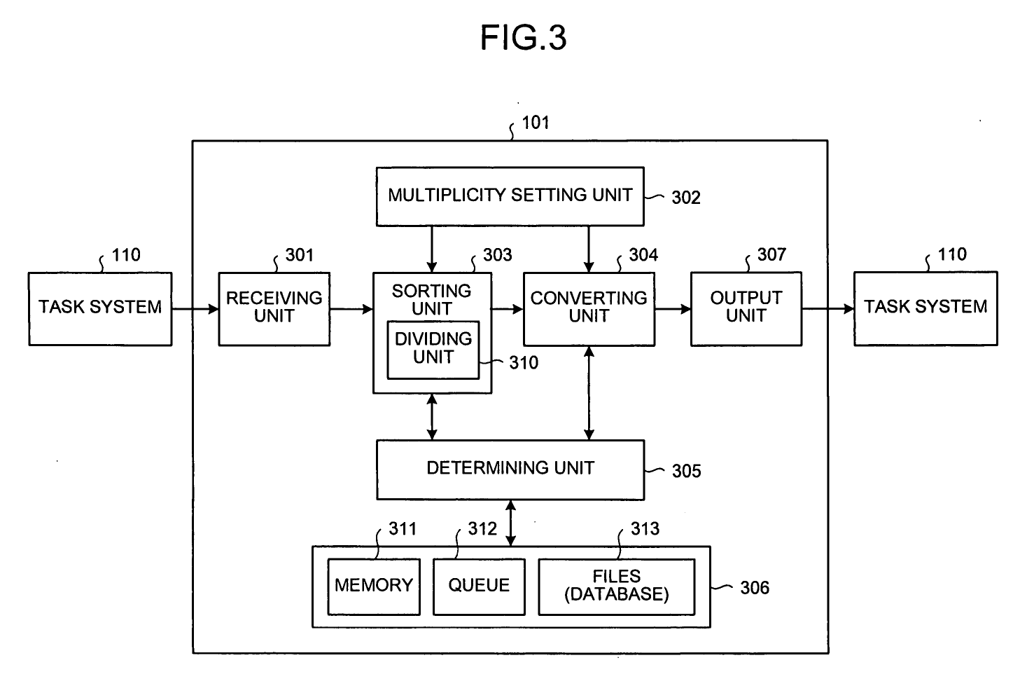

FIG. 3 is a block diagram of a system configuration of the data processing apparatus 101. As shown in FIG. 3, the data processing apparatus 101 includes a receiving unit 301, a multiplicity setting unit 302, a sorting unit 303, a converting unit 304, a determining unit 305, a storing unit 306, and an output unit 307.

The receiving unit 301 receives pieces of task data with different destinations being specified. The task data is transmitted from one or more task systems. The pieces of the task data are collectively stored in the storing unit 306 in an order in which the task data are received.

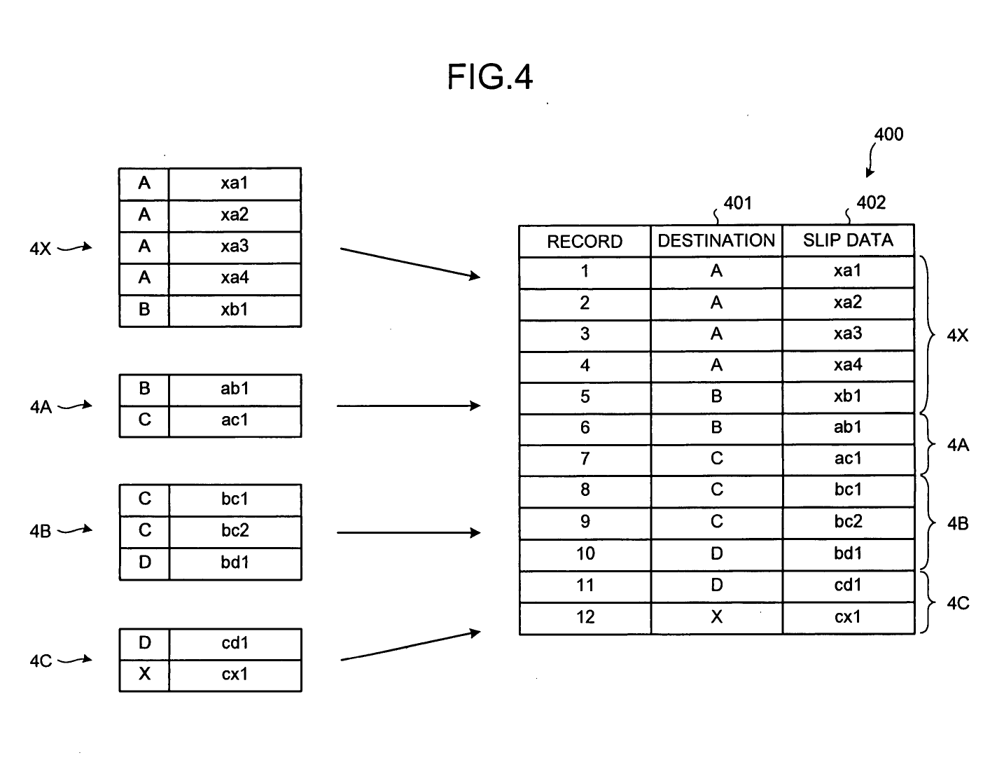

FIG. 4 is a schematic for illustrating an input process according to the embodiment. The receiving unit 301 receives the task data from an arbitrary one of the task systems. In this example, the receiving unit 301 receives task data 4X from the task system X, task data 4A from the task system A, task data 4B from the task system B, and task data 4C from the task system C.

As shown in FIG. 4, each of the task data 4X and 4A to 4C includes a destination header and slip data. The destination header indicates information by a character at the end of a symbol representing a task system to be a destination. For example, for the task data 4X, the destination header for slip data xa1 to xa4 is “A”. That is, the destination of the slip data xa1 to xa4 is the task system A. Information relevant to the destination header may be included in the slip data, or the destination may be determined from a correspondence between the information included in the slip data and a destination definition.

The task data 4X and 4A to 4C are retained as collective task data 400 in a file 313 in a unit of record that includes a destination field 401 and a slip data field 402. In the collective task data 400, the task data 4X and 4A to 4C are retained in the order in which the task data 4X and 4A to 4C are received.

The multiplicity setting unit 302 sets multiplicity of the data processing apparatus 101. Multiplicity represents the number of processes that are simultaneously and concurrently performed. Specifically, the multiplicity can be set by providing threads. The number of threads is determined depending on the number of units of the CPU 201 and the capacity of the memories (the RAM 203 and the HD 205). Thus, the sorting process by the sorting unit 303 and the conversion process by the converting unit 304 can be concurrently performed.

There is a limit in the number of threads depending on a machine size. By using a simple coefficient having a large influence on the performance, overhead can be reduced. At the time of start-up or a dynamic update of the system, if multiplicity has a value equal to or more than a threshold of a memory capacity of which information is collected by the link base, a concurrent process is performed running the threads while setting the limit to the number of CPUs. In some types of machines, the multiplicity is to a value obtained by multiplying the number of CPUs by a coefficient. This scheme does not usually require a setting operation of a user.

The sorting unit 303 sorts the task data received by the receiving unit 301, which is the collective task data 400 in the file 313, by destination. Specifically, the sorting unit 303 includes a dividing unit 310 that divides the collective task data 400 into the number of threads set by the multiplicity setting unit 302.

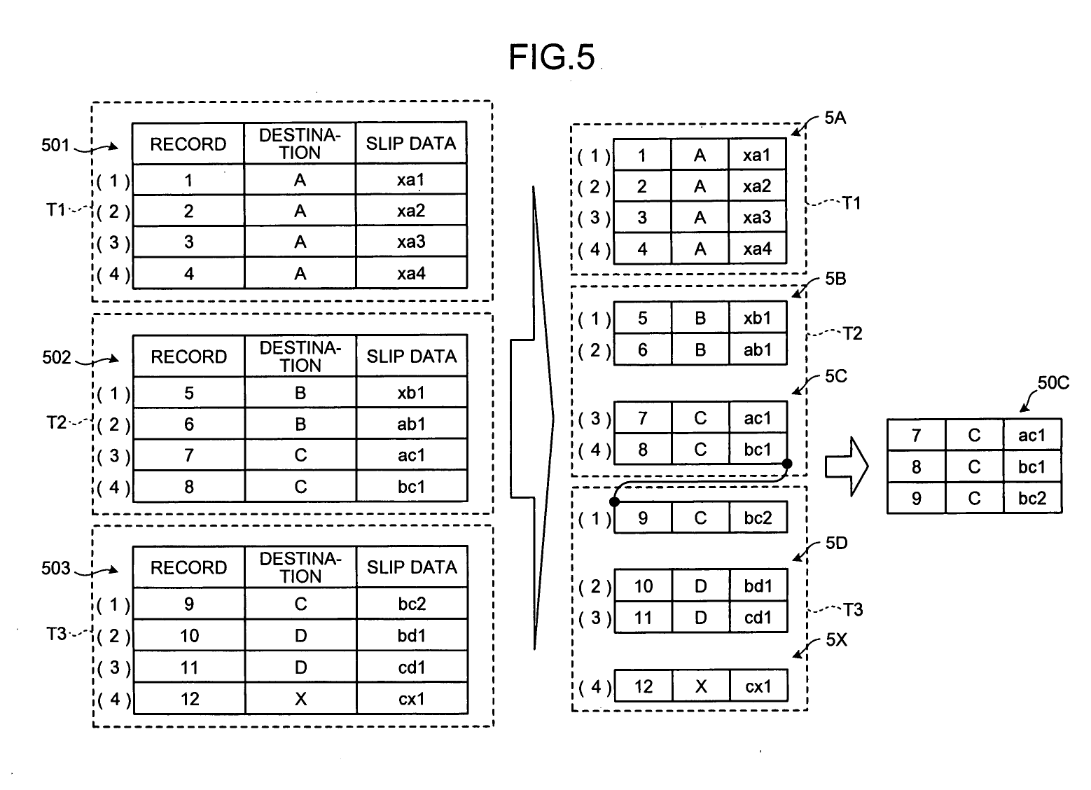

FIG. 5 is a schematic for illustrating a sorting process according to the embodiment. In FIG. 5, the sorting process performed on the collective task data 400 shown in FIG. 4 is depicted. In an example shown in FIG. 5, three threads are provided. Therefore, the collective task data 400 is divided into three groups. Such task data obtained as a result of division is hereinafter referred to as “divided task data”. Numerals in parentheses provided to each of divided task data 501 to 503 in the thread represent pointers that indicate a storage location. The sorting unit 303 concurrently performs the sorting process on the divided task data 501 to 503 while referring to the pointers. Specifically, the task data is sorted by the pointers an arranged in an order of the pointers referring to the destination field 401.

For example, in a thread T1, from the divided task data 501, the slip data xa1 having a pointer (1) is sorted as data to the destination A. Concurrently, in a thread T2, from the divided task data 502, slip data Xb1 having the pointer (1) is sorted as data to the destination B. In a thread T3, from the divided task data 503, slip data bc2 having the pointer (1) is sorted as data to the destination C.

Next, in the thread T1, from the divided task data 501, the slip data xa2 having the pointer (2) is sorted as data to the destination A. Concurrently, in the thread T2, from the divided task data 502, slip data Ab1 having the pointer (2) is sorted as data to the destination B. In the thread T3, from the divided task data 503, slip data bd1 having the pointer (2) is sorted as data to the destination D.

Next, in the thread T1, among the divided task data 501, the slip data xa3 having the pointer (3) is sorted as data to the destination A. Concurrently, in the thread T2, from the divided task data 502, slip data ac1 having the pointer (3) is sorted as data to the destination C. In the thread T3, from the divided task data 503, slip data cd1 having the pointer (3) is sorted as data to the destination D.

Next, in the thread T1, from the divided task data 501, the slip data xa4 having the pointer (4) is sorted as data to the destination A. Concurrently, in the thread T2, from the divided task data 502, slip data bc1 having the pointer (4) is sorted as data to the destination C. In the thread T3, from among the divided task data 503, slip data cx1 having the pointer (4) is sorted as data to the destination X. The pieces of task data after sorting are hereinafter referred to as sorted task data 5A, 5B, 5C, 5D and 5X.

In the sorting unit 303, the pointers of the data sorted in the threads T1 to T3 are reorganized according to destinations, and are reconnected in an order of the threads T1, T2, and then T3. In each of the threads T1 to T3, the sorting process is performed independently. Thus, even in the sorted task data, the task data are maintained in the order in which the task data are input, and can be transmitted to the destination in the order.

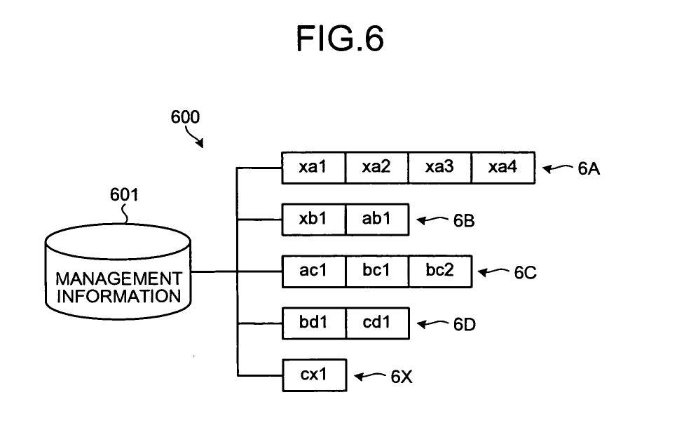

The sorting unit 303 generates combined task data in which the sorted task data 5A, 5B, 5C, 5D, and 5X are combined. FIG. 6 is schematic for illustrating the combined task data. As shown in FIG. 6, combined task data 600 includes management information 601 and slip data groups 6A, 6B, 6C, 6D, and 6X for respective destinations.

The slip data group 6A is a set of slip data for the destination A. The slip data group 6B is a set of slip data for the destination B. The slip data group 6C is a set of slip data for the destination C. The slip data group 6D is a set of slip data for the destination D. The slip data (group) 6X is a set of slip data for the slip data X for the destination X. The management information 601 includes information on volume of data of each slip data group and destinations to which the slip data groups are to be transmitted.

In most cases, each of the sorted task data has a different destination in the sorting unit 303. Therefore, it is not required to control a processing order for each of the destinations, and this enables multiprocessing that reduces processing time. When the machine has a sufficient size to perform multiprocessing, a process of conversion to data sorted by destination, a process of user application, log editing, and an output process are simultaneously performed with high efficiency. To achieve this, the process for each destination is dispatched to a thread for concurrent processing.

If the number of destinations is more than the number of the threads, dispatch is repeated for number of times up to the limit in the number of threads. Because the larger the data volume is, the more processing time is required, data having a larger data volume has priority in being assigned to the threads, and the data are assigned to the threads sequentially. As a result, to each of the threads, processes are equally assigned, and therefore the processes can be finished early.

Furthermore, in FIG. 3, the converting unit 304 converts each of the slip data groups 6A, 6B, 6C, 6D, and 6X sorted by destination into a format suitable depending on the destination. This format conversion process is concurrently performed in each of the threads T1 to T3 set by the multiplicity setting unit 302.

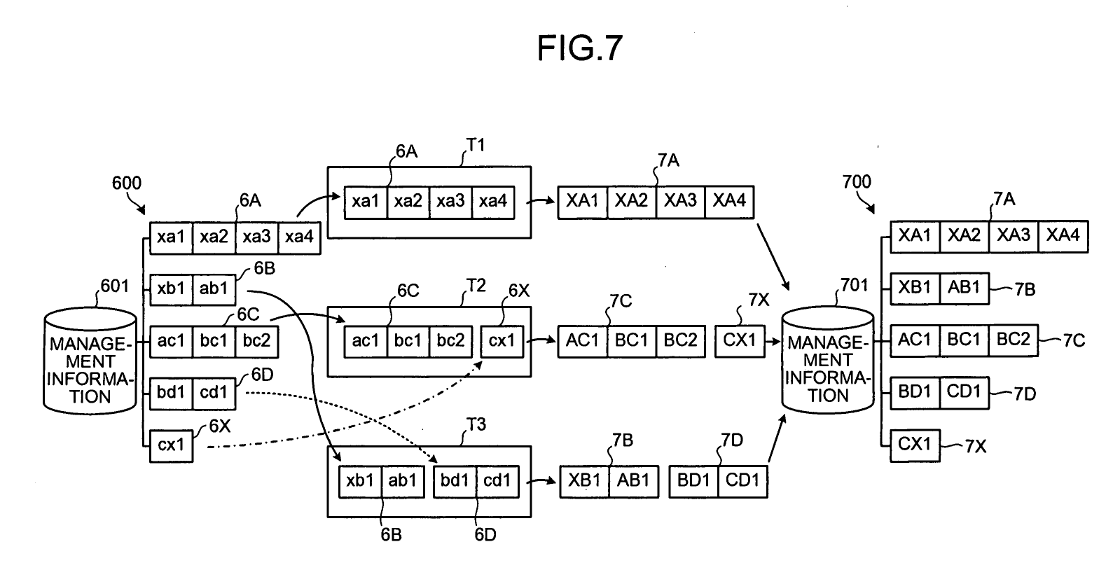

FIG. 7 is a schematic for illustrating a format conversion process according to the embodiment. As shown in FIG. 7, the slip data groups 6A, 6B, 6C, 6D, and 6X sorted by destination in the combined task data 600 are assigned to the threads T1 to T3. In assigning, the management information 601 is referred, and the slip data groups 6A, 6B, 6C, 6D, and 6X are assigned to the threads T1 to T3 in decreasing order of number of pieces (or volume) of data.

For example, it is assumed that each of the threads T1 to T3 accepts up to four pieces of slip data. First, the slip data group 6A including four pieces of data is assigned to the thread T1. Next, the slip data group 6C including three pieces of data is assigned to the thread T2. Then, the slip data group 6B including two pieces of data is assigned to the thread T3. The thread T3 still has a vacancy for two pieces of slip data, and therefore the slip data group 6D is assigned to the thread T3. The thread T2 still has a vacancy for one piece of slip data, and therefore the slip data group 6X (slip data cx1) is assigned to the thread T2.

Thus, slip data groups 7A (the slip data XA1 to XA4), 7B (the slip data XB1 and AB1), 7C (the slip data AC1, BC1, and BC2), 7D (the slip data BD1 and CD1), and 7X (the slip data CX1), on which the format conversion has been processed, are generated. The converting unit 304 combines the slip data groups 7A, 7B, 7C, 7D, and 7X to generate combined task data 700.

The combined task data 700 includes the slip data groups 7A, 7B, 7C, 7D, and 7X and management information 701. The management information 701 includes destinations, volume of data, and the number of pieces of data of the slip data groups 7A, 7B, 7C, 7D, and 7X.

In addition to a format conversion process, the converting unit 304 can concurrently perform a process of converting character code. Furthermore, other than function of converting a format and a character code, the converting unit 304 also has a check function (not shown) for concurrently checking contents of data. For example, for slip data, it is possible to concurrently check contents such as an amount on a slip, and a lack or omission of items required.

The determining unit 305 shown in FIG. 3 determines, after the sorting process or the format conversion process, the data volume of the combined task data 600 and 700 or the presence or absence of data assurance. Thus, a storage medium in which the combined task data 600 and 700 are stored during periods between the sorting process and the format conversion process and between the format conversion process and the output process is respectively determined.

Specifically, the storage medium is determined referring to a flag that indicates the data volume or the presence or absence of data assurance (effectiveness of a transaction process) of the combined task data 600 and 700. The flag is included in the management information 601 and 701. This leads to speeding up of writing and reading of the combined task data between the processes.

The storing unit 306 stores the combined task data 700 in the storage medium determined by the determining unit 305. Each of the storage media includes a memory 311, a queue 312, and a file 313 (a database for assuring transaction). The queue 312 is non-volatile.

The storing unit 306 switches to an appropriate storage medium (the memory 311, the queue 312, and the file 313) to store the combined task data 600 and 700. The combined task data 600 and 700 are retained by the pointers or file names of the management information 601 and 701, respectively. A threshold of the data volume is selectable. Also, volume of data of management information for reporting a process event to a link processing program is small. Such data with small volume is stored in the queue 312.

Furthermore, the output unit 307 outputs (transmits) the slip data groups 7A, 7B, 7C, 7D, and 7X in the combined task data 700 by destination. Specifically, an output process is performed by reading the combined task data 700 from the storing unit 306 and then by referring to the destinations in the management information 701.

Functions of the receiving unit 301, the multiplicity setting unit 302, the sorting unit 303, the converting unit 304, the determining unit 305, the storing unit 306, the output unit 307, and the dividing unit 310 are achieved by the CPU 201 executing programs recorded on the recording media, such as the ROM 202, the RAM 203, and the HD 205 shown in FIG. 2.

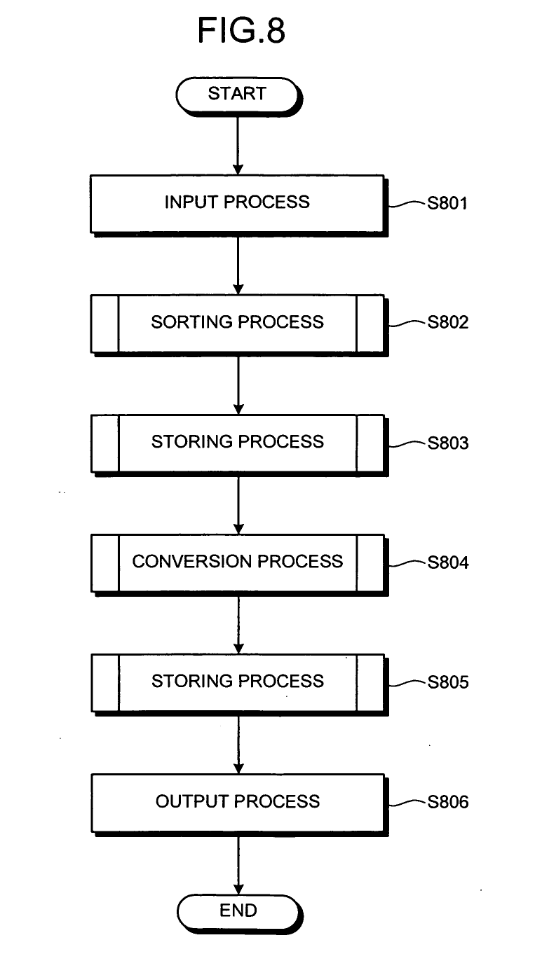

FIG. 8 is a flowchart of data processing by the data processing apparatus 101. As shown in FIG. 8, an input process is first performed by the receiving unit 301 (step S801). If the destination is not fixed to one destination, a sorting process is performed by the sorting unit 303 (step S802). Then, a process of storing the combined task data 600 obtained through the sorting process is performed (step S803). Next, the format conversion process is performed by the converting unit 304 (step S804). Then, a process of storing the combined task data 700 obtained through the format conversion process is performed (step S805). Finally, the output process is performed by the output unit 307 (step S806).

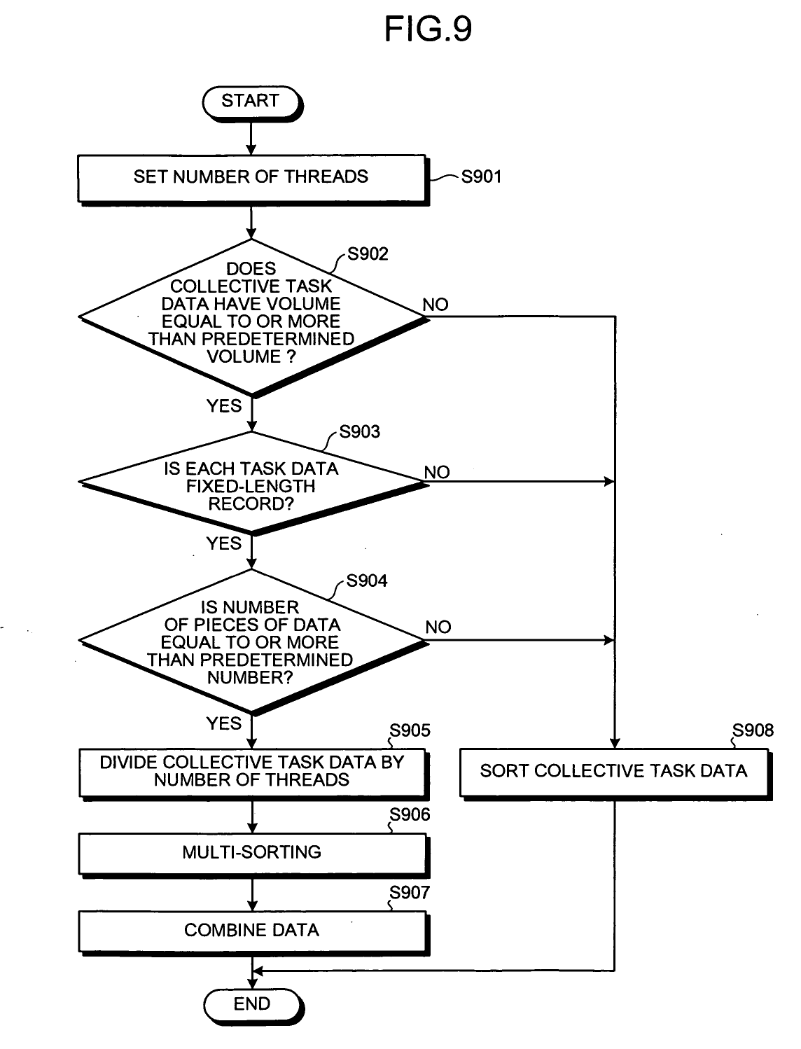

FIG. 9 is a flowchart of the sorting process. As shown in FIG. 9, the number of threads is first set by the multiplicity setting unit 302 (step S901). Next, it is determined whether the collective task data 400 input through the input process (step S801) and retained in the file 313 has a volume equal to or more than a predetermined volume (step S902).

If the collective task data 400 has a volume equal to or more than the predetermined volume (“YES” at step S902), it is determined whether each task data in the collective task data 400 is a fixed-length record (step S903). Thus, the unit of the slip data can be identified. If each task data is a fixed-length record (“YES at step S903), it is determined whether the number of pieces of task data in the collective task data 400 is equal to or more than a predetermined number (step S904). If the number of pieces of task data is equal to or more than the predetermined number (“YES” at step S904), the dividing unit 310 divides the collective task data 400 by the number of threads (step S905).

Then, in each of the threads T1 to T3, multi-sorting is performed, that is, the divided task data 501 to 503 are concurrently sorted by destination (step S906). Then, the sorted task data 5A, 5B, 5C, 5D, and 5X are combined (step S907). Thus, the combined task data 600 can be obtained.

If the collective task data 400 does not has a volume equal to or more than the predetermined volume at step S902 (“NO” at step S902), if each task data is not a fixed-length record at step S903 (“NO” at step S903), or if the number of pieces of task data is equal to or more than the predetermined number at step S904 (“NO” at step S904), the pieces of task data in the collective task data 400 are sorted by destination (step S908). Therefore, in this case, the collective task data 400 is not divided by the dividing unit 310.

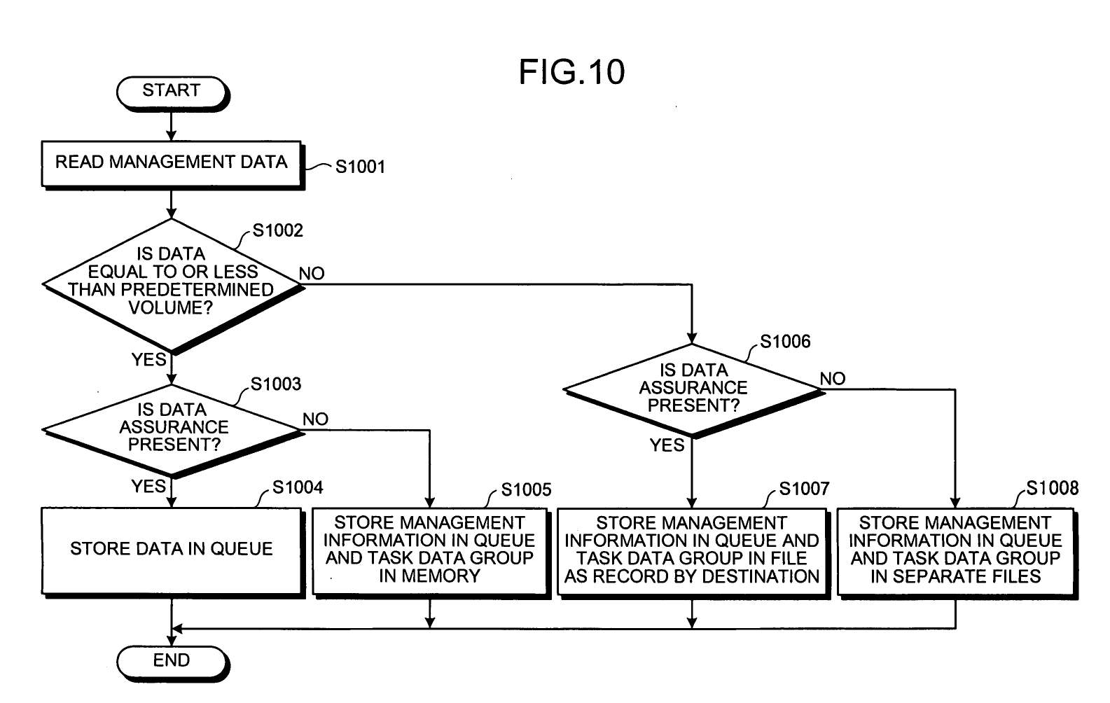

FIG. 10 is a flowchart of the storing process. In FIG. 10, the management information 601 and 701 of the combined task data 600 and 700 respectively are read (step S1001). If the combined task data 600 and 700 each have a volume equal to or less than a predetermined volume (“YES” at step S1002), it is determined whether data assurance is present (step S1003).

If data assurance is present (“YES” at step S1003), the collective task data 400 is stored in the queue 312 (step S1004). On the other hand, if data assurance is not present (“NO” at step S1003), the management information 601 and 701 are stored in the queue 312, and the task data groups are stored in the memory 311 (step S1005).

Also, when the collective task data 400 does not have a volume equal to or less than a predetermined volume at step S1002 (“NO” at step S1002), it is determined whether data assurance is present (step S1006). If data assurance is present (“YES” at step S1006), the management information 601 and 701 are stored in the queue 312 and the task data groups are stored by destination as records in the file 313 (the database for assuring transaction) (step S1007). On the other hand, if data assurance is not present (“NO” at step S1006), the management information is stored in the queue 312, and the task data groups are stored in separate files 313 (step S1008).

In the storing process, an appropriate recording medium can be selected according to operation requirements, such as the data volume and data assurance, thereby speeding up the concurrent process and saving resources.

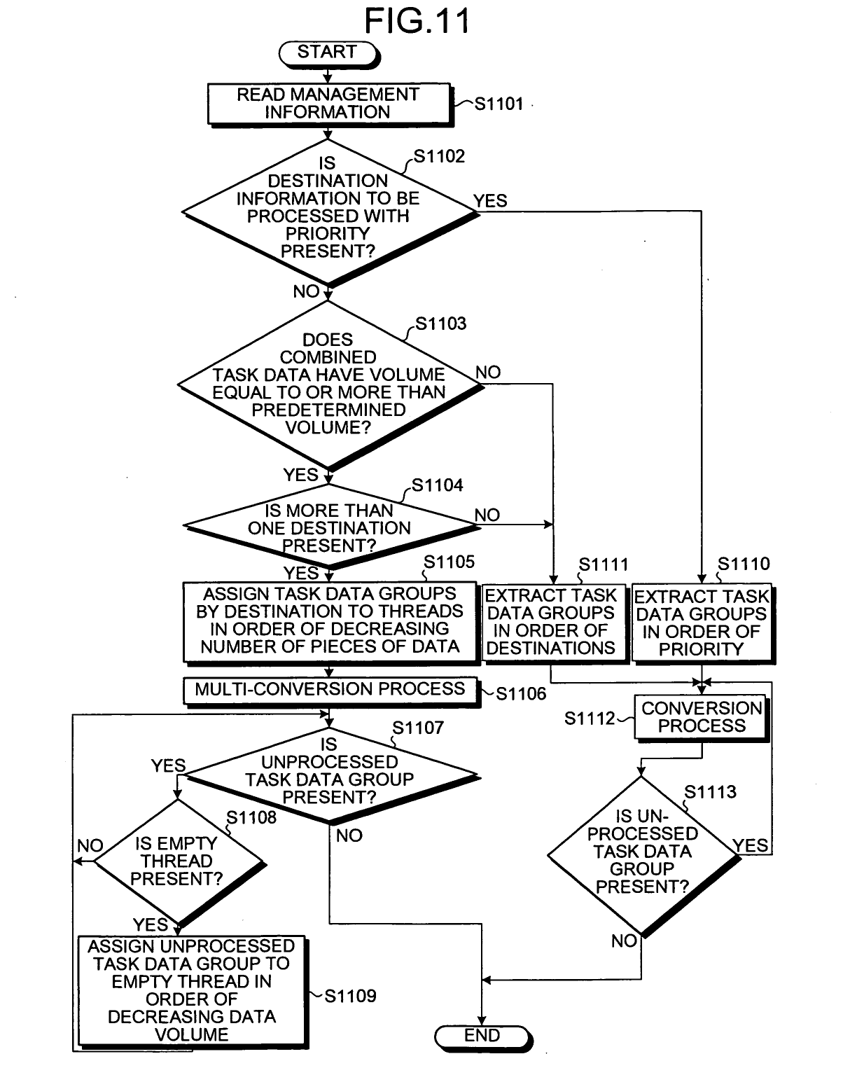

FIG. 11 is a flowchart of the format conversion process. In FIG. 11, the management information 601 of the combined task data 600 is first read (step S1101), and it is then determined whether destination information to be processed priority is present in the management information 601 (step S1102).

If destination information to be processed with priority is not present (“NO” at step S1102), it is determined whether the combined task data 600 has a volume equal to or more than a predetermined volume (step S1103). If the combined task data 600 has a volume equal to or more than the predetermined volume (“YES” at step S1103), it is determined whether plural destinations are present (step S1104). If plural destinations are present (“YES” at step S1104), a plurality of threads are to be used, and the task data groups by destination are assigned to the threads T1 to T3 in the order of decreasing number of pieces of data (step S1105).

Then, a multi-conversion process is performed, that is, the format conversion is concurrently performed for the threads T1 to T3 (step S1106). If an unprocessed task data group is not present (“NO” at step S1107), a series of format conversion processes ends. On the other hand, if an unprocessed task data group is present (“YES” at step S1107) and if an empty threads is present (“YES” at step S1108), the unprocessed task data groups are assigned to the empty threads in the order of decreasing data volume (step S1109). Then, after step S1109 or if no empty thread is present at step S1108 (“NO” at step S1108), the procedure goes to step S1107.

If destination information to be processed with priority is present at step S1102 (“YES” at step S1102), the task data groups are extracted in the order of priority (step S1110). If the combined task data 600 does not have a volume equal to or more than a predetermined volume at step S1103 (“NO” at step S1103), only one thread will suffice for use. Therefore, the task data groups are extracted in the order of destinations (step S1111). Similarly, if more than one destination is not present at step S1104 (“NO” at step S1104), the task data groups are extracted in the order of destinations (step S1111).

Then, after step S1110 or step S1111, a format conversion process is performed in the order of extraction (step S1112). If unprocessed task data groups are present (“YES” at step S1113), the procedure goes to step S1112. On the other hand, if unprocessed task data groups are not present (“NO” at step S1113), a series of processes ends.

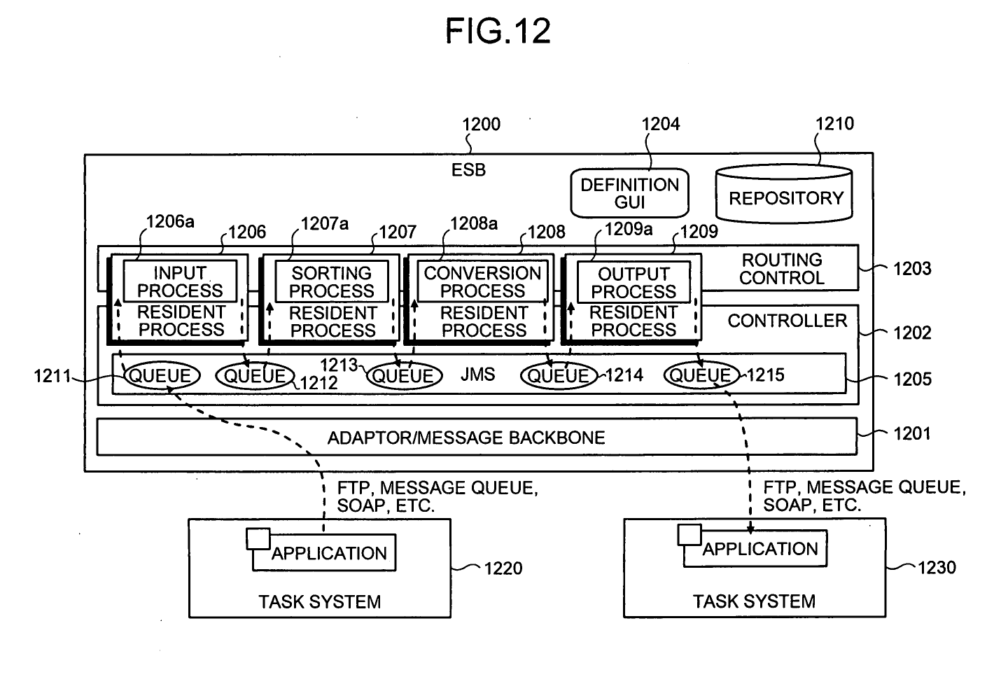

FIG. 12 is a block diagram of a specific configuration of the data processing apparatus 101. As shown in FIG. 12, an ESB 1200 includes an adaptor/message backbone 1201, a controller 1202, routing control 1203, definition graphical user interface (GUI) 1204, etc.

The ESB 1200 is a middleware technology serving as an infrastructure for application integration based on service oriented architecture (SOA), and serves as an integration broker that mutually links services (applications and components) developed in conformance with open standard specifications, such as a Web service or JCA.

The adaptor/message backbone 1201 performs control regarding message transfer of various protocols and synchronous (request response type)/asynchronous (detached type) link type. The controller 1202 is a basic control engine of the ESB 1200 for performing application execution control having functions of internal queue control, data consistency assurance by transaction control, multiplicity control, abnormality monitoring, etc. As a common framework for message exchange, Java Message Service (JMS) 1205 is preferably used, which is an asynchronous communication function of Java 2 Platform, Enterprise Edition (J2EE).

The routing control 1203 performs message destination control, route control, and processing program call control. Also, the routing control 1203 operates in cooperation with the controller 1202, and includes processing program 1206 to 1209 of various types of a resident process, such as an input process 1206a, a sorting process 1207a, a conversion process 1208a, an output process 1209a, a broadcasting process, a queuing process, an aggregation process, a division process, log editing, a check process, and a user application, and also includes definitions for controlling these calls. The definitions are created by the definition GUI 1204 and stored in a repository 1210.

Dotted lines shown in FIG. 12A represents a data flow. Data from a task system 1220 with various communication protocols, such as a file transfer protocol (FTP), a message queue, and a simple object access protocol (SOAP), is passed over the adaptor/message backbone 1201 via a queue 1211 of the JMS 1205 to the input process 1206a. Thereafter, with queues 1212 to 1215 of the JMS 1205 being taken as a trigger, an event report is issued, and then the control prevails throughout the processes, such as the sorting process 1207a and the conversion process 1208a.

Finally, the output process 1209a passes the process to the adaptor/message backbone 1201 via the JMS 1205 to transfer data to the task system 1230. During this system cooperative processing, collective data of large volume sorted into the sorting process 1207a and more than one destination or data having more than one destination are subjected to multiprocessing, thereby reducing a processing time.

As described, according to the data processing apparatus, the data processing method, and the computer product, it is possible, in system cooperative processing, to speed up a sorting process for slip data having large volume of data or many destinations for sorting and a data process on divided slip data with not only the performance in small-volume data cooperation but particularly with the main system and its cooperation.

Furthermore, pieces of data sorted by destination are collected into a single structure. With the use of a mechanism of automatically switching to an appropriate data recording medium depending on the data volume and the operation requirements, the number of process events, and the number of inputs and outputs can be reduced, and resources, such as memory, can be saved.

The sorting process and multiprocessing scheme on sorted data contribute to an increase in speed of processing for data having a large volume or data having many destinations for sorting. By performing multiprocessing and resource assignment with a relatively simple scheme, it is possible to achieve a general-purpose process with less overhead and without requiring complex management information.

The data processing method described in the present embodiment can be achieved by executing a previously-provided program on a computer, such as a personal computer or a work station. This program is recorded on a computer-readable recording medium, such as a hard disk, flexible disk, CD-ROM, MO, and DVD, and is executed as being read by the computer from the recording medium. Also, this program may be a transmission medium that can be distributed via a network, such as the Internet.

According to the present invention, data multiprocessing can be efficiently performed.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A data processing apparatus comprising:
a receiving unit that receives a plurality of pieces of data, each of which having a different destination specified;
a classifying unit that classifies the plurality of pieces of data into a predetermined number of groups;
a sorting unit that extracts data from the groups in a parallel manner, and that sorts the data extracted according to a destination; and
an output unit that outputs a set of the data sorted to a corresponding destination.

2. The data processing apparatus according to claim 1, wherein the sorting unit arranges data in the set of the data sorted based on a time of reception.

3. The data processing apparatus according to claim 2, further comprising a converting unit that assigns the set of the data to one of a predetermined number of threads and that converts a format of the set of the data assigned, in a parallel manner, depending on a destination, wherein
the output unit outputs the set of the data converted to the corresponding destination.

4. The data processing apparatus according to claim 2, further comprising a checking unit that assigns the set of the data sorted to one of a predetermined number of threads and that checks the set of the data assigned, in a parallel manner, depending on a destination, wherein
the output unit outputs the set of the data checked to the corresponding destination.

5. The data processing apparatus according to claim 3, further comprising:
a comparing unit that compares a data volume of the set of the data sorted with a predetermined threshold; and
a storing unit that stores the set of the data sorted in a storage medium selected from among a plurality of types of storage media based on a result of comparison by the comparing unit, wherein
the converting unit assigns the set of the data stored in the storage medium to one of the threads.

6. The data processing apparatus according to claim 3, further comprising:
a comparing unit that compares a data volume of the set of the data sorted with a predetermined threshold; and
a storing unit that stores the set of the data sorted in a storage medium selected from among a plurality of types of storage media based on a result of comparison by the comparing unit, wherein
the output units outputs the set of the data stored in the storage medium to the corresponding destination.

7. A data processing method comprising:
receiving a plurality of pieces of data, each of which having a different destination specified;
classifying the plurality of pieces of data into a predetermined number of groups;
extracting data from the groups in a parallel manner;
sorting the data extracted according to a destination; and
outputting a set of the data sorted to a corresponding destination.

8. The data processing method according to claim 7, further comprising arranging data in the set of the data sorted at the sorting based on a time of reception.

9. The data processing method according to claim 8, further comprising:
assigning the set of the data to one of a predetermined number of threads; and
converting a format of the set of the data assigned, in a parallel manner, depending on a destination, wherein
the outputting includes outputting the set of the data converted to the corresponding destination.

10. The data processing method according to claim 8, further comprising:
assigning the set of the data sorted to one of a predetermined number of threads; and
checking the set of the data assigned, in a parallel manner, depending on a destination, wherein
the outputting includes outputting the set of the data checked to the corresponding destination.

11. The data processing method according to claim 9, further comprising:
comparing a data volume of the set of the data sorted with a predetermined threshold;
storing the set of the data sorted in a storage medium selected from among a plurality of types of storage media based on a result of comparison at the comparing; and
assigning the set of the data stored in the storage medium to one of the threads.

12. The data processing method according to claim 9, further comprising:
comparing a data volume of the set of the data sorted with a predetermined threshold; and
storing the set of the data sorted in a storage medium selected from among a plurality of types of storage media based on a result of comparison at the comparing, wherein
the outputting includes outputting the set of the data stored in the storage medium to the corresponding destination.

13. A computer-readable recording medium that stores a data processing program therein, the data processing program making a computer execute:
receiving a plurality of pieces of data, each of which having a different destination specified;
classifying the plurality of pieces of data into a predetermined number of groups;
extracting data from the groups in a parallel manner;
sorting the data extracted according to a destination; and
outputting a set of the data sorted to a corresponding destination.

14. The computer-readable recording medium according to claim 13, wherein the data processing program further makes the computer execute arranging data in the set of the data sorted at the sorting based on a time of reception.

15. The computer-readable recording medium according to claim 14, wherein the data processing program further makes the computer execute:
assigning the set of the data to one of a predetermined number of threads; and
converting a format of the set of the data assigned, in a parallel manner, depending on a destination, wherein
the outputting includes outputting the set of the data converted to the corresponding destination.

16. The computer-readable recording medium according to claim 14, wherein the data processing program further makes the computer execute:
assigning the set of the data sorted to one of a predetermined number of threads; and
checking the set of the data assigned, in a parallel manner, depending on a destination, wherein
the outputting includes outputting the set of the data checked to the corresponding destination.

17. The computer-readable recording medium according to claim 15, the data processing program further makes the computer execute:
comparing a data volume of the set of the data sorted with a predetermined threshold;
storing the set of the data sorted in a storage medium selected from among a plurality of types of storage media based on a result of comparison at the comparing; and
assigning the set of the data stored in the storage medium to one of the threads.

18. The computer-readable recording medium according to claim 15, wherein the data processing program further makes the computer execute:
comparing a data volume of the set of the data sorted with a predetermined threshold; and
storing the set of the data sorted in a storage medium selected from among a plurality of types of storage media based on a result of comparison at the comparing, wherein
the outputting includes outputting the set of the data stored in the storage medium to the corresponding destination.
